(19) United States
(12) Patent Application Publication
(10) Pub. No.: US 2023/0330548 A1
(43) Pub. Date: Oct. 19, 2023

(54) Inflatable Decoration and Storage Device

(71) Applicant: Brian Garratt, Lutz, FL (US)

(72) Inventor: Brian Garratt, Lutz, FL (US)

(21) Appl. No.: 18/186,461

(22) Filed: Mar. 20, 2023

Related U.S. Application Data
(60) Provisional application No. 63/330,395, filed on Apr. 13, 2022.

(51) Int. Cl. A63H 3/06; F16M 11/24

(52) U.S. Cl. CPC A63H 3/06; F16M 11/24

(57) ABSTRACT

The present invention relates to an inflatable decoration and storage device primarily comprised of at least one base, comprised of at least one inflatable stored within the base that can be filled with air using at least one fan within the base. The inflatable can be inflated via the fan such that the inflatable inflates outward from the base. The inflatable can then be deflated, wherein a drawstring within the inflatable is shortened via a motorized spool within the base such that the inflatable is automatically moved within the base. The drawstring also automatically closes a door of the base.

### CROSS-REFERENCE TO RELATED APPLICATION

The present application claims priority to, and the benefit of, U.S. Provisional Application No. 63/330,395, which was filed on Apr. 13, 2022, and is incorporated herein by reference in its entirety.

### FIELD OF THE INVENTION

The present invention relates generally to the field of inflatable decorations. More specifically, the present invention relates to an inflatable decoration and storage device primarily comprised of at least one base, comprised of at least one inflatable stored within the base that can be filled with air using at least one fan within the base. The inflatable can be inflated via the fan such that the inflatable inflates outward from the base. The inflatable can then be deflated, wherein a drawstring within the inflatable is shortened via a motorized spool within the base such that the inflatable is automatically moved within the base. The drawstring also automatically closes a door of the base. Accordingly, the present disclosure makes specific reference thereto. Nonetheless, it is to be appreciated that aspects of the present invention are also equally applicable to other like applications, devices, and methods of manufacture.

### BACKGROUND

Many individuals enjoy displaying inflatable, seasonal lawn decorations. However, individuals may not wish to display said decorations at all times, especially during periods of inclement weather. As a result, each time an individual wishes to stop displaying an inflatable lawn decoration they must deflate the decoration and manually bring the decoration inside. Alternatively, an individual can leave the decoration in a deflated state outside. However, doing so risks damage to the decoration due to weather exposure.

Therefore, there exists a long-felt need in the art for a device that can store an inflatable lawn decoration. In addition, there exists a long-felt need in the art for an inflatable decoration and storage device that can store a deflated lawn decoration when the decoration is not in use. There also exists a long-felt need in the art for an inflatable decoration and storage device that protects a deflated lawn decoration from the weather when the decoration is not in use. Further, there exists a long-felt need in the art for an inflatable decoration and storage device that does not require an inflatable lawn decoration to be physically moved when it is deflated and not being used.

The subject matter disclosed and claimed herein, in one embodiment thereof, comprises an inflatable decoration and storage device. The device is primarily comprised of at least one base, comprised of at least one inflatable stored within the base that can be filled with air using at least one fan within the base. The inflatable can be inflated via the fan such that the inflatable inflates outward from the base. The inflatable is supported in an inflatable position by at least one internal drawstring. The inflatable can then be deflated, wherein the drawstring is shortened via a motorized spool within the base such that the inflatable is automatically moved within the base. The drawstring also automatically closes a door of the base such that a user need not physically position the deflated inflatable back into the base and close the door of the base.

In this manner, the inflatable decoration and storage device of the present invention accomplishes all of the foregoing objectives and provides a device that can store an inflatable lawn decoration when the decoration is not in use. Further, the device protects a deflated lawn decoration from the weather when the decoration is not in use. In addition, the device does not require an inflatable lawn decoration to be physically moved when it is deflated and not being used.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable decoration and storage device primarily comprised of at least one base, comprised of at least one inflatable stored within the base that can be filled with air using at least one fan within the base. The base stores the inflatable when not in use and also functions as a stand for the inflatable during use. The base may resemble any object, item, animal, character, theme, etc., known in the art. In the preferred embodiment, the base is square and resembles a Christmas present in appearance. In differing embodiments, the inflatable may also resemble any object, item, character, person, mascot, theme, etc., known in the art. It is preferred that the theme of the inflatable matches the theme of the base. In one embodiment, the base is a Christmas present, and the inflatable is a Christmas-themed character.

In one embodiment, the bottom surface of the base is preferably comprised of at least one leg that provides stability to the base. The top wall of the base is comprised of at least one door that attaches to a side wall of the base via at least one hinge that allows the door to open when the inflatable is inflated (via the fan) such that the inflatable is displayed above the base. When deflated, the inflatable is stored within the interior space of the base, wherein the door offers protection to the inflatable from the weather.

The device is comprised of at least one fan located within (or is at least connected to) the inflatable such that powering on the fan inflates and/or deflates the inflatable. The inflatable may be comprised of at least one internal drawstring that provides internal support and structure to the inflatable. The drawstring is connected to at least one motorized spool located within the base. The drawstring is attached to the spool such that rotation of the spool in a first direction shortens the drawstring in length. The drawstring is run through at least one drawstring guide that may be positioned on the door, within the interior space, and/or within the inflatable such that the rotation of the spool retracts the drawstring (i.e., by shortening the drawstring in length) to push the inflatable down into the interior space (while or after it has been deflated by the fan) and shuts the door over the inflatable once inside the interior space. As a result, a user need not physically place the inflatable back into the interior space after it has been deflated. When inflating the inflatable, the spool can be rotated in a second direction such that the drawstring lengthens, and the drawstring has enough slack to allow the inflatable to expand such that it becomes taunt within the inflatable to provide stability to the inflatable.

Accordingly, the inflatable decoration and storage device of the present invention is particularly advantageous as it provides a device that can store an inflatable lawn decoration when the decoration is not in use. In addition, the device protects a deflated lawn decoration from the weather when the decoration is not in use and does not require the inflatable lawn decoration to be physically moved when it is deflated and not being used. In this manner, the inflatable decoration and storage device overcomes the limitations of existing inflatable decorations known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an inflatable decoration and storage device of the present invention while fully inflated in accordance with the disclosed architecture;

FIG. 2 illustrates an enhanced perspective view of a base and drawstring guides of one potential embodiment of an inflatable decoration and storage device of the present invention while fully inflated in accordance with the disclosed architecture;

FIG. 3 illustrates a perspective view of one potential embodiment of an inflatable decoration and storage device of the present invention while fully deflated with an opened base in accordance with the disclosed architecture; and

FIG. 4 illustrates a perspective view of one potential embodiment of an inflatable decoration and storage device of the present invention while fully deflated with a closed base in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can store an inflatable lawn decoration. In addition, there exists a long-felt need in the art for an inflatable decoration and storage device that can store a deflated lawn decoration when the decoration is not in use. There also exists a long-felt need in the art for an inflatable decoration and storage device that protects a deflated lawn decoration from the weather when the decoration is not in use. Further, there exists a long-felt need in the art for an inflatable decoration and storage device that does not require an inflatable lawn decoration to be physically moved when it is deflated and not being used.

The present invention, in one exemplary embodiment, is comprised of an inflatable decoration and storage device primarily comprised of at least one base, comprised of at least one inflatable stored within the base that can be filled with air using at least one fan within the base. The base stores the inflatable when not in use and also functions as a stand for the inflatable during use. The base may resemble any object, item, animal, character, theme, etc., known in the art. In the preferred embodiment, the base is square and resembles a Christmas present in appearance. However, in differing embodiments, the inflatable may also resemble any object, item, character, person, mascot, theme, etc., known in the art. It is preferred that the theme of the inflatable matches the theme of the base. In one embodiment, the base is a Christmas present, and the inflatable is a Christmas-themed character.

In one embodiment, the bottom surface of the base is preferably comprised of at least one leg that provides stability to the base. The top wall of the base is comprised of at least one door that attaches to a side wall of the base via at least one hinge. The hinge allows the door to open when the inflatable is inflated (via the fan) such that the inflatable is displayed above the base. When deflated, the inflatable is stored within the interior space of the base. When this occurs, the door offers protection to the inflatable from the weather.

The device is comprised of at least one fan located within (or is at least connected to) the inflatable. Powering on the fan inflates and/or deflates the inflatable. The inflatable may be comprised of at least one internal drawstring that provides internal support and structure to the inflatable. The drawstring is connected to at least one motorized spool located within the base. The drawstring is attached to the spool such that rotation of the spool in a first direction shortens the drawstring in length. The drawstring is run through at least one drawstring guide that may be positioned on the door, within the interior space, and/or within the inflatable such that the rotation of the spool retracts the drawstring (i.e., by shortening the drawstring in length) to push the inflatable down into the interior space (while or after it has been deflated by the fan) and shuts the door over the inflatable once inside the interior space. Therefore, a user need not physically place the inflatable back into the interior space after it has been deflated. When inflating the inflatable, the spool can be rotated in a second direction such that the drawstring lengthens, and the drawstring has enough slack to allow the inflatable to expand such that it becomes taunt within the inflatable to provide stability to the inflatable.

Accordingly, the inflatable decoration and storage device of the present invention is particularly advantageous as it provides a device that can store an inflatable lawn decoration when the decoration is not in use. In addition, the device protects a deflated lawn decoration from the weather when the decoration is not in use and does not require an inflatable lawn decoration to be physically moved when it is deflated and not currently being used. In this manner, the inflatable decoration and storage device overcomes the limitations of existing inflatable decorations known in the art.

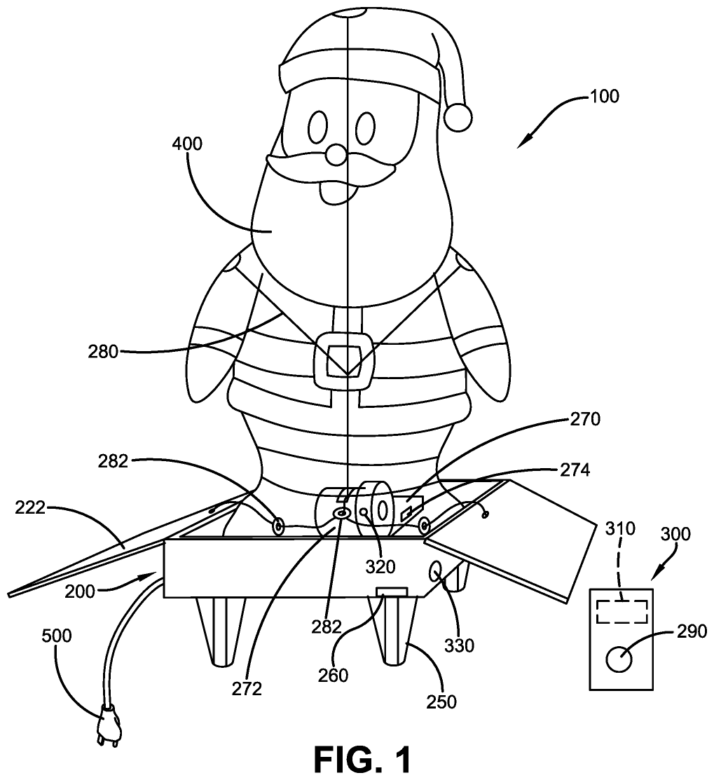

Referring initially to the drawings, FIG. 1 illustrates a perspective view of one potential embodiment of an inflatable decoration and storage device 100 of the present invention while fully inflated in accordance with the disclosed architecture. The device 100 is primarily comprised of at least one base 200, comprised of at least one inflatable 400 stored within the base 200 that can be filled with air using at least one fan 270 within the base 200. In the preferred embodiment, the base 200 is made from a durable metal material such as, but not limited to, stainless steel or aluminum that is rustproof/waterproof. The base 200 may also be made from a plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The base 200 stores the inflatable 400 when not in use and also functions as a stand for the inflatable 400 during use. The base 200 may resemble any object, item, person, animal, character, theme, etc., known in the art. In the preferred embodiment, the base 200 is square and resembles a Christmas present in appearance. In differing embodiments, the inflatable 400 may resemble any object, item, character, person, mascot, theme, animal, etc., known in the art. It is preferred that the theme of the inflatable 400 matches the theme of the base 200. In one embodiment, the base 200 is a Christmas present and the inflatable 400 is a Christmas-themed character.

In one embodiment, the bottom surface 210 of the base 200 is preferably comprised of at least one leg 250 that provides stability to the base 200. The leg 250 may be of a fixed or adjustable length. The leg 250 may fixedly attach to the base 200 or removably attach to the base 200 via at least one leg fastener 260 such as, but not limited to, screw, bolt, tongue and groove, hook and loop, magnet, clip, etc., or at least one hinge 224 such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

In the preferred embodiment, the top wall 220 of the base 200 is comprised of at least one door 222 that attaches to a side wall 230 of the base 200 via at least one hinge 224. The hinge 224 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 224 allows the door 222 to open when the inflatable 400 is inflated (via the fan 270) such that the inflatable 400 is displayed above the base 200. When deflated, the inflatable 400 is stored within the interior space 240 of the base 200, wherein the door 222 offers protection to the inflatable 400 from the weather. In one embodiment the door 222 is comprised of at least one fastener 226 such as, but not limited to, a latch, a clasp, a tie, a lock, etc., that allows the door 222 to be secured to the sidewall 230 and/or another door 222 in an embodiment of the device 100 with two doors 222. In this manner, the door 222 cannot inadvertently open during storage/transport. In one embodiment, the door 222 may be comprised of a transparent material.

The device 100 is comprised of at least one fan 270. The fan 270 may be any type of electrically powered fan known in the art. The fan 270 is located within the interior space 240 of the base 200. In one embodiment, the fan 270 is located within (or is at least connected to) the inflatable 400 such that powering on the fan 270 inflates and/or deflates the inflatable 400.

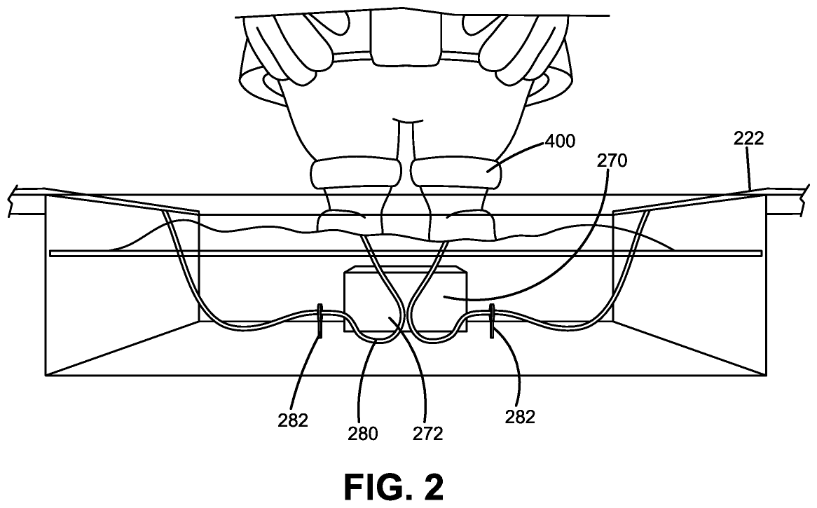

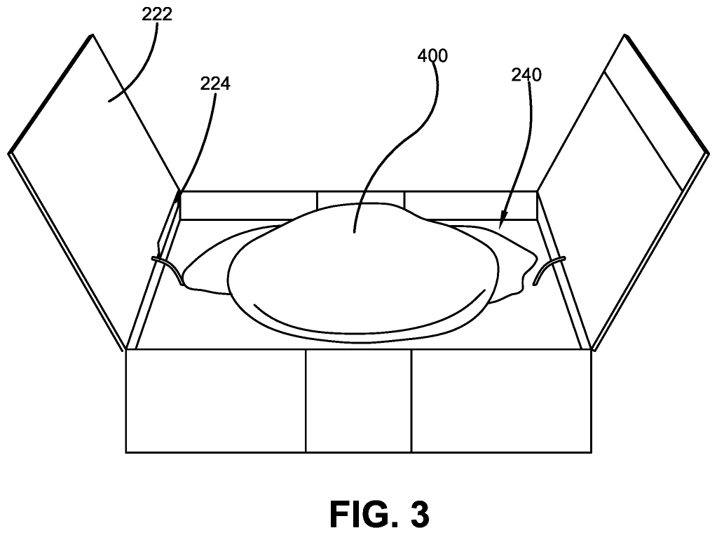

The inflatable 400 may be comprised of at least one internal drawstring 280 that is preferably transparent such that it cannot be seen within the inflatable 400. The drawstring 280 may be made from any rope material known in the art. The drawstring 280 provides internal support and structure to the inflatable 400. The drawstring 280 is connected to at least one motorized spool 272 located within the base 200. The spool 272 may be more specifically located within or below the inflatable 400. The drawstring 280 is attached to the spool 272 such that rotation of the spool 272 in a first direction shortens the drawstring 280 in length. The drawstring is run through at least one drawstring guide 282 (as best seen in FIG. 2) that may be positioned on the door 222, within the interior space 240, and/or within the inflatable 400 such that the rotation of the spool 272 retracts the drawstring 280 (i.e., by shortening the drawstring 280 in length) to push the inflatable 400 down into the interior space 240 (while or after it has been deflated by the fan 270) and shuts the door 222 over the inflatable 400 once inside the interior space 240, as seen in FIG. 3. In this manner, a user need not physically place the inflatable 400 back into the interior space 240 after it has been deflated. When inflating the inflatable 400, the spool 272 can be rotated in a second direction such that the drawstring lengthens and the drawstring 280 has enough slack to allow the inflatable 400 to expand. Once in the inflated position, the drawstring 280 is taunt within the inflatable 400 to provide stability to the inflatable 400.

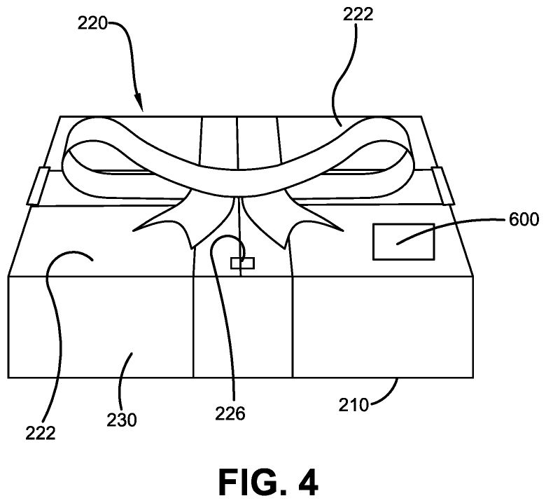

The fan 270 and spool 272 are in electrical communication with and are powered by at least one battery 274. The battery 274 may be a disposable battery 274 or a rechargeable battery 274 in the form of an alkaline, nickel-cadmium, nickel-metal hydride battery 274, etc., such as any 3V-12 volts DC battery 274 or other conventional battery 274 such as A, AA, AAA, etc., that supplies power to the device 100. Throughout this specification the terms “battery” and “batteries” may be used interchangeably to refer to one or more wet or dry cells or batteries 274 of cells in which chemical energy is converted into electricity and used as a source of DC power. References to recharging or replacing batteries 274 may refer to recharging or replacing individual cells, individual batteries 274 of cells, or a package of multiple battery cells as is appropriate for any given battery 274 technology that may be used. In one embodiment, the fan 270 and spool 272 are powered by at least one 110V or 220V power cord 500. In one embodiment, the battery 274 is charged via at least one solar panel 600 positioned on the base 200, as seen in FIG. 4. The solar panel 600 may be comprised of, but not limited to, monocrystalline silicon, polycrystalline silicon, or a photovoltaic cell film.

In one embodiment, the fan 270 and spool 272 are each comprised of at least one receiver 320 that is in wireless electrical communication with Bluetooth, Wi-Fi, RFID, etc., with at least one transmitter 310 of at least one remote 300. In this manner, at least one button 290 on the remote 300 can be used to control the functions of the fan 270 (inflate/deflate) and spool 272 (rotate a first direction/rotate a second direction). Alternatively, the base 200 may be comprised of at least one button 330 that serves the same function as the remote 300 button 290. It should be appreciated the when the fan 270 is inflating the inflatable 400 the spool 272 is simultaneously rotating in a first direction to allow the drawstring 280 to lengthen and vice versa.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable decoration and storage device” and “device” are interchangeable and refer to the inflatable decoration and storage device 100 of the present invention.

Notwithstanding the foregoing, the inflatable decoration and storage device 100 of the present invention and its various components can be of any suitable size and configuration as is known in the art without affecting the overall concept of the invention, provided that they accomplish the above-stated objectives. One of ordinary skill in the art will appreciate that the size, configuration and material of the inflatable decoration and storage device 100 as shown in the FIGS. are for illustrative purposes only, and that many other sizes and shapes of the inflatable decoration and storage device 100 are well within the scope of the present disclosure. Although the dimensions of the inflatable decoration and storage device 100 are important design parameters for user convenience, the inflatable decoration and storage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inflatable decoration and storage device comprising:
a base having a door;
a motorized spool;
a fan;
a battery;
an inflatable; and
a drawstring.

2. The inflatable decoration and storage device of claim 1, wherein the inflatable is an object, an item, a character, a person, an animal or a mascot.

3. The inflatable decoration and storage device of claim 1, wherein the inflatable is positioned within the base when deflated.

4. The inflatable decoration and storage device of claim 1, wherein the fan is attached to the inflatable.

5. An inflatable decoration and storage device comprising:
a base having a leg;
a door that attaches to the base via a hinge;
a motorized spool;
an inflatable;
a drawstring guide;
a drawstring positioned within the inflatable; and
a fan connected to the inflatable.

6. The inflatable decoration and storage device of claim 5, wherein the leg is an adjustable length leg.

7. The inflatable decoration and storage device of claim 5, wherein the drawstring is comprised of a transparent material.

8. An inflatable decoration and storage device comprising:
a base comprised of a leg and a leg fastener;
a first door that attaches to the base via a first hinge;
a second door that attaches to the base via a second hinge;
a fastener;
a battery;
a motorized spool;
an inflatable;
a receiver;
a transmitter;
a drawstring guide;
a drawstring positioned within the inflatable; and
a fan connected to the inflatable.

9. The inflatable decoration and storage device of claim 8, wherein the leg fastener is comprised of a hinge, a screw, a bolt, a clip, or a magnet.

10. The inflatable decoration and storage device of claim 8, wherein the fastener secures the first door to the second door.

11. The inflatable decoration and storage device of claim 10, wherein the fastener is comprised of a latch, a clasp, a tie, or a lock.

12. The inflatable decoration and storage device of claim 8 further comprised of a solar panel.

13. The inflatable decoration and storage device of claim 12, wherein the solar panel provides power to the battery.

14. The inflatable decoration and storage device of claim 8, wherein the drawstring is connected to the motorized spool.

15. The inflatable decoration and storage device of claim 8, wherein the motorized spool can rotate a first direction and a second direction.

16. The inflatable decoration and storage device of claim 8 further comprised of a remote that controls the fan and the motorized spool.

17. The inflatable decoration and storage device of claim 8, wherein the drawstring is positioned through the drawstring guide.

18. The inflatable decoration and storage device of claim 17, wherein the drawstring guide is positioned in an interior space of the base.

19. The inflatable decoration and storage device of claim 17, wherein the drawstring guide is positioned on the first door.

20. The inflatable decoration and storage device of claim 17, wherein the drawstring guide is positioned on the second first door.
